(19) United States
(12) Patent Application Publication
(10) Pub. No.: US 2014/0043721 A1
(43) Pub. Date: Feb. 13, 2014

(54) MULTILAYER CERAMIC ELECTRONIC COMPONENT AND METHOD OF MANUFACTURING THE SAME

(71) Applicant: SAMSUNG ELECTRO-MECHANICS CO., LTD., Suwon (KR)

(72) Inventors: Jong Han KIM, Suwon (KR); Eung Soo KIM, Suwon (KR); Seung Ho LEE, Suwon (KR); Jae Yeol CHOI, Suwon (KR)

(73) Assignee: SAMSUNG ELECTRO-MECHANICS CO., LTD., Suwon (KR)

(21) Appl. No.: 13/828,607

(22) Filed: Mar. 14, 2013

(30) Foreign Application Priority Data
Aug. 8, 2012 (KR) 10-2012-0086909

(51) Int. Cl. H01G 4/005; H01G 4/12

(52) U.S. Cl. CPC H01G 4/005; H01G 4/12
USPC 361/301.4

(57) ABSTRACT

There are provided a multilayer ceramic electronic component and a method of manufacturing the same, the multilayer ceramic electronic component, including: a ceramic body including a plurality of dielectric layers laminated therein, each dielectric layer having an average thickness of 0.65 μM or less; internal electrodes disposed to face each other while having each dielectric layer interposed therebetween in the ceramic body; and external electrodes electrically connected to the internal electrodes, wherein, when td denotes the average thickness of each of the dielectric layers and te denotes an average thickness of each of the internal electrodes, te/td≦0.77 is satisfied.

### CROSS-REFERENCE TO RELATED APPLICATIONS

This application claims the priority of Korean Patent Application No. 10-2012-0086909 filed on Aug. 8, 2012, in the Korean Intellectual Property Office, the disclosure of which is incorporated herein by reference.

### BACKGROUND OF THE INVENTION

1. Field of the Invention

The present invention relates to a multilayer ceramic electronic component and a method of manufacturing the same, and more particularly, to a multilayer ceramic electronic component in which cracking due to thermal impact may be suppressed and reliability improved, and a method of manufacturing the same.

2. Description of the Related Art

In general, a multilayer ceramic capacitor (MLCC) is a chip type condenser commonly mounted on a printed circuit board used in various types of electronic equipment such as a mobile communications device, a notebook computer, a personal computer, a personal digital assistant (PDA), and the like, and playing an important role of charging or discharging electricity. A multilayer ceramic capacitor may have various sizes and lamination types according to the usages and capacity thereof.

In accordance with the recent trend for the miniaturization of electronic products, demand for multilayer ceramic electronic components having a small size and high capacitance has increased. Due to this demand, attempts at thinning dielectric layers and inner electrode layers and stacking the dielectric layers and inner electrode layers in ever greater numbers have been undertaken using various methods. Recently, as the thickness of dielectric layers has been reduced, multilayer ceramic electronic components having larger numbers of stacked layers have been manufactured.

In order to realize this high capacitance, methods of increasing the number of dielectric layers and internal electrode layers able to be stacked by reducing the thicknesses thereof are common. However, as dielectric layers and the internal electrode layers have been thinned, the thickness of internal electrode layers may not be uniform and the internal electrode layers may not be formed to be continuous, and thus, the inner electrode layer may be partially disconnected, resulting in a deterioration of connection properties.

In the case in which the internal electrode is not continuously connected and is partially disconnected, such that a part of the internal electrode is not formed and correspondingly, the area of the internal electrode may decrease to result in a reduction in capacitance, the area distribution of the internal electrode may be increased according to the disconnection degree of the internal electrode and the distribution of capacitance may also be increased, resulting in a decrease in yield.

Moreover, besides capacitance, the generation of cracking due to an increase in internal stress caused by a difference in shrinkage behavior between the internal electrode and the dielectric layer is an important consideration.

As the multilayer ceramic capacitor has ultrahigh capacitance, a ratio between the thickness of the dielectric layer and thickness of the internal electrode (thickness of internal electrode/thickness of dielectric layer) may be increased, and as the number of laminations increases, fraction of internal electrodes inside the ceramic body may also be increased.

Therefore, when the fraction of internal electrodes is at a predetermined level or higher, several types of cracks may be generated.

The following related art document discloses that the ratio between the thickness of the dielectric layer and the thickness of the internal electrode is controlled, but it is difficult to prevent cracks from occurring in the ultrasmall, ultrahigh capacitance multilayer ceramic capacitor.

### RELATED ART DOCUMENT

### Patent Documents

(Patent Document 1) Japan Patent Laid-Open Publication No. 2012-094809

### SUMMARY OF THE INVENTION

An aspect of the present invention provides a multilayer ceramic electronic component in which cracking due to thermal impact may be suppressed and reliability improved by increasing the continuity of an internal electrode layer and controlling a ratio of a thickness of an internal electrode to a thickness of a dielectric layer and the thickness of the dielectric layer, and a method of manufacturing the same.

According to an aspect of the present invention, there is provided a multilayer ceramic electronic component, including: a ceramic body including a plurality of dielectric layers laminated therein, each dielectric layer having an average thickness of 0.65 μm or less; internal electrodes disposed to face each other while having each dielectric layer interposed therebetween in the ceramic body; and external electrodes electrically connected to the internal electrodes, wherein, when td denotes the average thickness of each of the dielectric layers and te denotes an average thickness of each of the internal electrodes, te/td≦0.77 is satisfied.

The internal electrodes may respectively have an average thickness of 0.25 to 0.5 μm.

When an area formed of the dielectric layers and the internal electrodes contributing to capacitance formation in the ceramic body is designated as an active area, a ratio of a volume of the dielectric layers to a volume of the internal electrodes in the active area may be 1.3 or more.

The internal electrodes may be laminated in an amount of 200 layers or more.

According to another aspect of the present invention, there is provided a multilayer ceramic electronic component, including: a ceramic body including a plurality of dielectric layers laminated therein, each dielectric layer having an average thickness of 0.65 μm or less; internal electrodes disposed to face each other while having each dielectric layer interposed therebetween in the ceramic body; and external electrodes electrically connected to the internal electrodes, wherein, when an area formed of the dielectric layers and the internal electrodes contributing to capacitance formation in the ceramic body is designated as an active area, a ratio of a volume of the dielectric layers to a volume of the internal electrodes in the active area is 1.3 or more.

The internal electrodes may respectively have an average thickness of 0.25 to 0.5 μm. The internal electrodes may be laminated in an amount of 200 layers or more.

According to another aspect of the present invention, there is provided a method of manufacturing a multilayer ceramic electronic component, the method including: preparing ceramic green sheets by using a slurry containing a ceramic powder; forming internal electrode patterns on the respective ceramic green sheets by using a conductive paste containing a metal powder; laminating and sintering the ceramic green sheets to form a ceramic body including dielectric layers and a plurality of internal electrodes disposed to face each other while having each dielectric layer interposed therebetween; and forming external electrodes on exterior surfaces of the ceramic body, wherein the dielectric layers respectively have an average thickness of 0.65 μm, and, when td denotes the average thickness of each of the dielectric layers and te denotes an average thickness of each of the internal electrodes, te/td≦0.77 is satisfied.

The internal electrodes may respectively have an average thickness of 0.25 to 0.5 μm.

When an area formed of the dielectric layers and the internal electrodes contributing to capacitance formation in the ceramic body is designated as an active area, a ratio of a volume of the dielectric layers to a volume of the internal electrodes in the active area may be 1.3 or more.

The internal electrodes may be laminated in an amount of 200 layers or more.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a perspective view schematically showing a multilayer ceramic capacitor according to an embodiment of the present invention;

FIG. 2 is a cross-sectional view taken along line A-A′ of FIG. 1;

FIG. 3 is an enlarged view of Part S of FIG. 2; and

FIG. 4 is a view showing a process of manufacturing a multilayer ceramic capacitor according to another embodiment of the present invention.

### DETAILED DESCRIPTION OF THE INVENTION

Hereinafter, embodiments of the present invention will be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art. In the drawings, the shapes and dimensions of elements may be exaggerated for clarity, and the same reference numerals will be used throughout to designate the same or like elements.

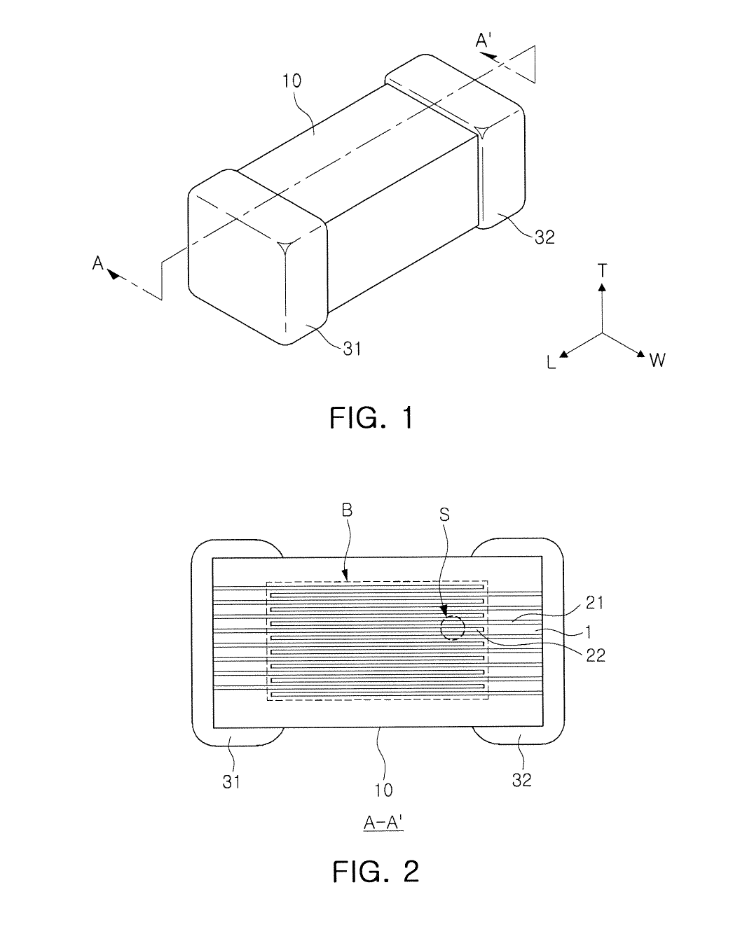

FIG. 1 is a perspective view schematically showing a multilayer ceramic capacitor according to an embodiment of the present invention.

FIG. 2 is a cross-sectional view taken along line A-A′ of FIG. 1.

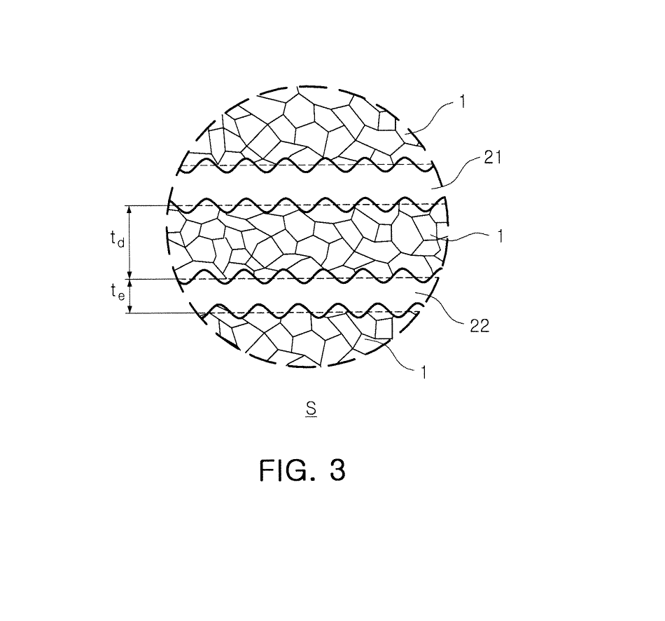

FIG. 3 is an enlarged view of Part S of FIG. 2.

Referring to FIGS. 1 to 3, a multilayer ceramic electronic component according to an embodiment of the present invention may include: a ceramic body 10 including a plurality of dielectric layers 1 laminated therein, each dialectic layer 1 having an average thickness of 0.65 μm or less; internal electrodes 21 and 22 disposed to face each other while having each dielectric layer 1 interposed therebetween in the ceramic body 10; and external electrodes 31 and 32 electrically connected to the internal electrodes 21 and 22. Here, when td denotes an average thickness of each of the dielectric layers 1 and te denotes an average thickness of each of the internal electrodes 21 and 22, te/td≦0.77 may be satisfied.

Hereinafter, as the multilayer ceramic electronic component according to the embodiment of the present invention, particularly, a multilayer ceramic capacitor will be described by way of example, but the present invention is not limited thereto.

The ceramic body 10 may have a hexahedral shape, but is not limited thereto.

Meanwhile, in the multilayer ceramic capacitor according to the embodiment, a ‘length direction’, a ‘width direction’, and a ‘thickness direction’ are respectively defined by ‘L’ direction, ‘W’ direction, and ‘T’ direction in FIG. 1. Here, the ‘thickness direction’ may be used to have the same meaning as a direction in which the dielectric layers are laminated, that is, a ‘lamination direction’.

According to the embodiment of the present invention, a raw material for forming the dielectric layers 1 is not particularly limited as long as sufficient capacitance can be obtained therewith. For example, the raw material may be a barium titanate (BaTiO₃) powder.

As a material for forming the dielectric layers 1, various ceramic additives, organic solvents, plasticizers, binders, dispersants, or the like may be added to powder, such as the barium titanate (BaTiO₃) powder, according to intended purposes of the present invention.

A material for forming the internal electrodes 21 and 22 is not particularly limited, but may be, for example, a conductive paste formed of at least one of silver (Ag), lead (Pg), platinum (Pt), nickel (Ni), and copper (Cu).

The multilayer ceramic capacitor according to the embodiment of the present invention may include the external electrodes 31 and 32 electrically connected to the internal electrodes 21 and 22.

The external electrodes 31 and 32 may be electrically connected to the internal electrodes 21 and 22 for forming capacitance.

A material for forming the external electrodes 31 and 32 is not particularly limited. The external electrodes 31 and 32 may be formed of the same conductive material as that of the internal electrode, for example, at least one selected from the group consisting of copper (Cu), nickel (Ni), silver (Ag), and silver-palladium (Ag—Pd).

According to the embodiment of the present invention, the average thickness of each of the dielectric layers 1 may be 0.65 μm or less, but is not limited thereto.

The present invention relates to an ultrasmall, ultrahigh capacitance multilayer ceramic capacitor, and as described above, the average thickness of each of the dielectric layers 1 may be 0.65 μm or less.

In general, when the dielectric layers 1 each have the average thickness greater than 0.65 μm, the average thickness of the dielectric layers 1 is large, and thus, internal cracks may not occur even in the case that a ratio of the average thickness of the internal electrodes to the average thickness of the dielectric layers 1 satisfies 1:1.

However, when the dielectric layers 1 each have the average thickness equal to or less than 0.65 μm, internal cracks may occur, depending on the ratio of the average thickness of the internal electrodes to the average thickness of the dielectric layers 1.

Therefore, in the embodiment of the present invention, the average thickness of each of the dielectric layers 1 may be, but is not limited to, 0.65 μm or less.

In the embodiment of the present invention, a thickness of respective dielectric layers 1 may refer to an average thickness of each of the dielectric layers 1 disposed between the first and second inner electrodes 21 and 22.

The average thickness of each of the dielectric layers 1 may be measured from an image obtained by scanning a cross section of the ceramic body 10 in a length direction thereof using a scanning electron microscope (SEM), as shown in FIG. 2.

For example, as shown in FIG. 2, the average thickness of each of the dielectric layers 1 may be obtained by measuring thicknesses of a dialectic layer in 30 equidistantly spaced locations in the length direction, the dielectric layer being extracted from the image obtained by scanning the cross section of the ceramic body 10 in length and thickness (L-T) directions taken in the central portion of the ceramic body 10 in the width (W) direction using the SEM, as shown in FIG. 2, and then averaging the measured thicknesses.

The thicknesses of the dielectric layer 1 in 30 equidistantly spaced locations may be measured within an active area B meaning an area in which the internal electrodes 21 and 22 overlap each other.

The average particle diameter of ceramic powder used in forming the dielectric layers 1 is not particularly limited, and may be controlled in order to achieve intended uses of the present invention, and for example, may be controlled to be 400 nm or less.

According to the embodiment of the present invention, when td denotes the average thickness of each of the dielectric layers 1 and te denotes the average thickness of each of the internal electrodes 21 and 22, te/td≦0.77 may be satisfied.

As such, the average thickness (td) of the dielectric layer 1 and the average thickness (te) of the internal electrode 21 or 22 may be controlled to satisfy te/td≦0.77, thereby preventing internal cracks from occurring in the multilayer ceramic capacitor.

In addition, the average thickness (td) of the dielectric layer 1 and the average thickness (te) of the internal electrode 21 or 22 may be controlled to satisfy te/td≦0.77, thereby improving continuity of the internal electrode, and thus realizing high capacitance.

When the average thickness (td) of the dielectric layer 1 is 0.65 μm or less, in the case in which te/td satisfies 1.0, a difference in sintering shrinkage between the dielectric layer and the internal electrode may cause internal stress of the multilayer ceramic capacitor to be increased.

In general, cracks may frequently occur inside multilayer ceramic capacitors due to stress.

In the present invention, it can be seen that, when the ratio (te/td) of the average thickness (te) of the internal electrode 21 or 22 to and the average thickness (td) of the dielectric layer 1 satisfies 0.77 or less (≦0.77), occurrence of internal cracking due to an increase in stress can be prevented.

That is, when the ratio (te/td) of the average thickness (te) of the internal electrode 21 or 22 to the average thickness (td) of the dielectric layer 1 is above 0.77, cracking may occur inside the multilayer ceramic capacitor.

In addition, according to the embodiment of the present invention in order to satisfy the above ratio, the average thickness (te) of the internal electrode 21 or 22 may satisfy the range of 0.25 to 0.5 μm, but is not limited thereto.

When the average thickness (te) of the internal electrode 21 or 22 is below 0.25 μm, it is difficult to secure electrode continuity when the average thickness (td) of the dielectric layer 1 is 0.65 μm or less, failing to implement capacitance.

When the average thickness (te) of the internal electrode 21 or 22 is above 0.5 μm, the thickness of the internal electrode is large, and thus, internal cracks may not be generated, as described above.

The average thickness of the internal electrode 21 or 22 may be measured from the image obtained by scanning the cross section of the ceramic body 10 in the length direction thereof using a scanning electron microscope (SEM), as shown in FIG. 2.

For example, as shown in FIG. 2, the average thickness of the internal electrode 21 or 22 may be obtained by measuring thicknesses of an internal layer in 30 equidistantly spaced locations in the length direction, the internal layer being extracted from the image obtained by scanning the cross section of the ceramic body 10 in length and thickness (L-T) directions taken in the central portion of the ceramic body 10 in the width (W) direction using the SEM, as shown in FIG. 2, and then averaging the measured thicknesses.

The thickness of the internal layer 21 or 22 in the 30 equidistantly spaced locations may be measured in the active area B, an area in which the internal electrodes 21 and 22 overlap each other.

According to the embodiment of the present invention, when an area formed of the dielectric layers 1 and the internal electrodes 21 and 22 contributing to capacitance formation in the ceramic body 10 is designated as the active area B, a ratio of a volume of the dielectric layers 1 to a volume of the internal electrodes 21 and 22 may be 1.3 or more in the active area B.

The ratio of a volume of the dielectric layers 1 to a volume of the internal electrodes 21 and 22 in the active area B is controlled to be 1.3 or more, so that occurrence of internal cracks in the multilayer ceramic capacitor can be prevented.

In addition, the ratio of a volume of the dielectric layers 1 to a volume of the internal electrodes 21 and 22 in the active area B is controlled to be 1.3 or more, so that continuity of the internal electrode can be improved, thereby realizing a high capacitance.

When the ratio of a volume of the dielectric layers 1 to a volume of the internal electrodes 21 and 22 in the active area B is below 1.3, the continuity of the internal electrode may be deteriorated, failing to realize high capacitance.

That is, the internal electrode is sintered at a temperature lower than the sintering temperature of the dielectric layer. Therefore, at the sintering temperature of the dielectric layer, the internal electrode may be more severely disconnected as the thickness of the internal electrode is decreased.

Due to this, the continuity of the internal electrodes may be deteriorated, resulting in reducing capacitance between the internal layers, and thus, failing to realize a high-capacitance multilayer ceramic capacitor.

In addition, according to the embodiment of the present invention, the internal electrodes 21 and 22 are laminated in an amount of 200 layers or more.

When the internal electrodes 21 and 22 are laminated in an amount of below 200 layers, internal cracks may not be generated in the multilayer ceramic capacitor regardless of the ratio of average thickness (te) of the internal electrode 21 or 22 to average thickness (td) of the dielectric layer 1.

A multilayer ceramic electronic component according to another embodiment of the present invention may include: a ceramic body 10 including a plurality of dielectric layers 1 laminated therein, each dialectic layer 1 having an average thickness of 0.65 μm or less; internal electrodes 21 and 22 disposed to face each other while having each dielectric layer 1 interposed therebetween in the ceramic body 10; and external electrodes 31 and 32 electrically connected to the internal electrodes 21 and 22. Here, when an area formed of the dielectric layers 1 and the internal electrodes 21 and 22 contributing to capacitance formation in the ceramic body 10 is designated as an active area B, a ratio of a volume of the dielectric layers 1 to a volume of the internal electrodes 21 and 22 in the active area B may be 1.3 or more.

The characteristics of the multilayer ceramic electronic component according to another embodiment of the present invention are the same as those of the multilayer ceramic electronic component according to the above-described embodiment of the present invention, and herein, descriptions thereof will be omitted in order to avoid repeated explanations.

The average thickness of the internal electrode 21 or 22 may be 0.25 to 0.5 μm, and the internal electrodes 21 and 22 may be laminated in an amount of 200 layers or more.

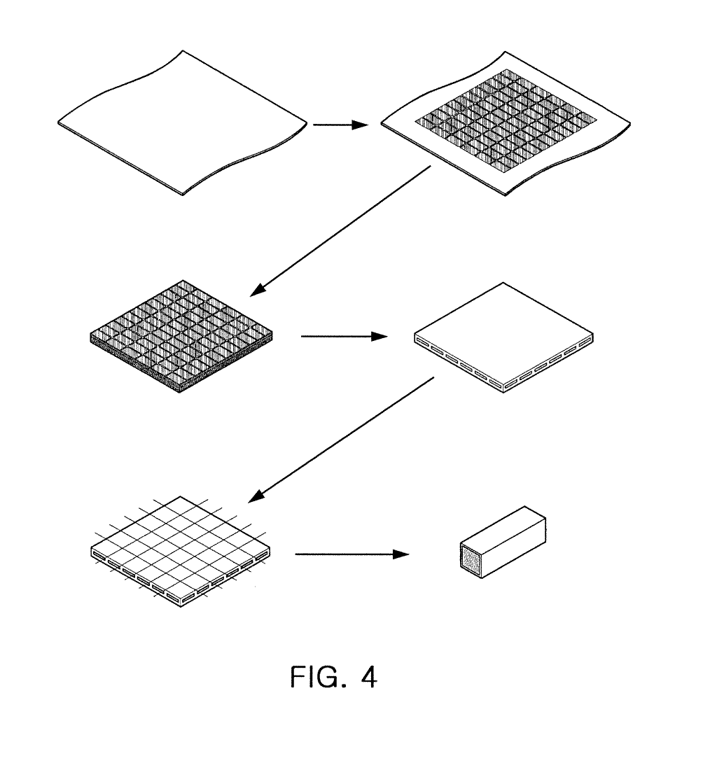

FIG. 4 is a view showing a process of manufacturing a multilayer ceramic electronic component according to another embodiment of the present invention.

Referring to FIG. 4, a method of manufacturing a multilayer ceramic electronic component according to another embodiment is provided, the method including: preparing ceramic green sheets by using a slurry containing a ceramic powder; forming internal electrode patterns on the respective ceramic green sheets by using a conductive paste containing a metal powder; laminating and sintering the ceramic green sheets to form a ceramic body including dielectric layers and a plurality of internal electrodes disposed to face each other while having each dielectric layer interposed therebetween; and forming external electrodes on exterior surfaces of the ceramic body. Here, an average thickness of each of the dielectric layers may be 0.65 μM or less, and, when td denotes the average thickness of each of the dielectric layers and te denotes an average thickness of each of the internal electrodes, te/td≦0.77 may be satisfied.

Hereinafter, the method of manufacturing a multilayer ceramic electronic component according to another embodiment of the present invention, particularly, a multilayer ceramic capacitor, will be described, but the present invention is not limited thereto.

First, a plurality of green sheets are prepared. The dielectric layers 1 may be formed of ceramic green sheets and each ceramic green sheet is prepared to have a thickness of several micrometers (μm). The ceramic green sheet is prepared by applying a slurry formed by mixing powder such as a barium titanate (BaTiO₃) powder or the like with a ceramic additive, an organic solvent, a plasticizer, a binder, and a dispersing agent onto a carrier film through a use of a basket mill and then drying the applied slurry.

According to another embodiment of the present invention, the dielectric layers 1 are each formed to have an average thickness of 0.65 μm or less.

Then, internal electrode layers may be formed by dispensing the conductive paste on the ceramic green sheet and moving a squeegee in one direction.

Here, the conductive paste may be formed of at least one of a noble metal such as silver (Ag), lead (Pb), platinum (Pt), or the like, nickel (Ni), copper (Cu) or a combination of at least two thereof.

After the internal electrode layers are formed as described above, the ceramic green sheet is separated from the carrier film and then a plurality of the ceramic green sheets are overlapped and laminated to form a ceramic green sheet laminate.

Then, the ceramic green sheet laminate may be compressed at a high temperature and pressure condition and then cut to have a predetermined size through a cutting process, whereby a green chip is prepared.

Thereafter, the multilayer ceramic capacitor is completed by performing a baking process, a firing process, a polishing process, an external electrode forming process, a plating process, and the like.

The completed multilayer ceramic capacitor may satisfy te/td≦0.77, when td denotes an average thickness of the dielectric layer and te denotes an average thickness of the internal electrode.

Hereafter, the present invention will be described in detail with reference to the examples, but is not limited thereto.

A conductive paste for internal electrodes was prepared by using nickel particles having an average size of 0.05 to 0.2 μm, and the nickel content was 45 to 55%. Internal electrodes were formed by a screen printing process, and the internal electrodes are laminated in an amount of 200 to 270 layers to form a ceramic laminate. After that, compressing and cutting were performed to produce 1005-standard size chips, and each of the chips was sintered at a temperature of 1050 to 1200° C. under a reducing atmosphere of H₂ of 0.1% or less. Then, an external electrode forming process, a plating process, and the like were performed to manufacture a multilayer ceramic capacitor. As the result of observing a cross section of the multilayer ceramic capacitor, the average thickness of each of the internal electrodes was determined to be 0.25 to 0.5 μm, and the average thickness of each of the dielectric layers was 0.65 μm or less.

In addition, when a thermal impact, such as mounting or the like, was applied to the ceramic laminate, cracks may be generated in an interface between upper and lower portions of the ceramic laminate and the internal electrodes due to a difference in thermal expansion between the dielectric layers and the internal electrodes.

In order to suppress cracks of the internal electrode and the dielectric layer due to thermal impact, samples were manufactured such that the average thickness (td) of the dielectric layer 1 and the average thickness (te) of the internal electrode 21 or 22 satisfies te/td≦0.77. After that, in order to evaluate cracks due to thermal impact, the sample was immersed in a lead bath at 320° C. for 2 seconds, and it was determined whether cracks occur or not by using a microscope with a magnification of 50 to 1,000 times.

Table 1 below compares Comparative Examples 1 to 6 and Inventive Examples 1 to 7 of the present invention with respect to capacitance, withstand voltage, and number of times that cracks occur due to thermal impact. The samples were manufactured by varying continuity of the internal electrode and a thickness ratio of the internal electrode layer to the dielectric layer.

The comparative examples were manufactured such that the average thickness of the internal electrode was outside of the range of 0.25 to 0.5 μm and the average thickness of the dielectric layer was outside of the range of 0.65 μm or less, and the thickness ratio of the internal electrode to the dielectric layer was above 0.77.

TABLE 1

| | | | Thickness of | | | |
|---|---|---|---|---|---|---|
| | | | internal | | | |
| | Thickness | Thickness | electrode | | | Occurrence |
| | of | of | to | | | of cracks |
| | dielectric | internal | dielectric | | | due to |
| | layer | electrode | layer | Number of | | thermal |
| No. | (μm) | (μm) | (te/td) | laminations | Capacitance | impact |
| 1* | 0.7 | 0.75 | 1.071 | 198 | ◯ | X |
| 2* | 0.7 | 0.7 | 1.000 | 205 | ◯ | X |
| 3* | 0.7 | 0.5 | 0.714 | 212 | ◯ | X |
| 4* | 0.65 | 0.7 | 1.077 | 207 | ◯ | ◯ |
| 5* | 0.65 | 0.6 | 0.923 | 210 | ◯ | ◯ |
| 6* | 0.65 | 0.55 | 0.846 | 220 | ◯ | ◯ |
| 7 | 0.65 | 0.5 | 0.769 | 222 | ⊚ | X |
| 8* | 0.6 | 0.65 | 1.083 | 214 | ◯ | ◯ |
| 9* | 0.6 | 0.6 | 1.000 | 218 | ◯ | ◯ |
| 10* | 0.6 | 0.55 | 0.917 | 220 | ◯ | ◯ |
| 11* | 0.6 | 0.5 | 0.833 | 190 | X | ◯ |
| 12* | 0.6 | 0.48 | 0.800 | 222 | □ | ◯ |
| 13 | 0.6 | 0.45 | 0.750 | 227 | □ | X |
| 14 | 0.6 | 0.35 | 0.583 | 232 | ◯ | X |
| 15 | 0.6 | 0.25 | 0.417 | 240 | ◯ | X |
| 16* | 0.6 | 0.23 | 0.383 | 242 | X | X |
| 17* | 0.55 | 0.55 | 1.000 | 220 | ◯ | ◯ |
| 18* | 0.55 | 0.50 | 0.909 | 224 | □ | ◯ |
| 19 | 0.55 | 0.42 | 0.764 | 230 | □ | X |
| 20 | 0.55 | 0.40 | 0.727 | 234 | □ | X |
| 21 | 0.55 | 0.30 | 0.545 | 247 | ◯ | X |
| 22* | 0.55 | 0.24 | 0.455 | 250 | X | X |
| 23* | 0.5 | 0.45 | 0.900 | 230 | □ | ◯ |
| 24 | 0.5 | 0.40 | 0.800 | 249 | □ | X |
| 25 | 0.5 | 0.30 | 0.600 | 251 | ◯ | X |
| 26* | 0.5 | 0.25 | 0.500 | 255 | X | X |
| 27* | 0.4 | 0.40 | 1.000 | 252 | □ | ◯ |
| 28* | 0.4 | 0.35 | 0.875 | 258 | □ | ◯ |
| 29 | 0.4 | 0.30 | 0.750 | 265 | □ | X |
| 30 | 0.4 | 0.25 | 0.625 | 273 | X | X |

*Comparative Example outside of the range of the present invention
X: Poor (75% or less)
◯: Good (75~85%)
⊚: Very Good (85% or more)

It can be seen from Table 1 above, that, in the cases of Samples 7, 13 to 15, 19 to 21, 24, 25, and 29, Inventive Examples of the present invention, the average thickness of the dielectric layer, the average thickness of the internal electrode, and the thickness ratio of the internal electrode to the dielectric layer satisfied the ranges of the present invention, and thus capacitance was excellent and internal cracks did not occur.

Conversely, it can be seen that, in the case of Samples 1 to 6, 8 to 12, 16 to 18, 22, 23, 26 to 28, and 30, Comparative Examples of the present invention, some of the average thickness of the dielectric layer, the average thickness of the internal electrode, and the thickness ratio of the internal electrode to the dielectric layer were not within the ranges of the present invention, and thus, capacitance was defective or internal cracks occurred.

According to the embodiments of the present invention, the thickness ratio of the internal electrode to the dielectric layer is controlled to be 0.77 or less, thereby allowing the thickness of the dielectric layer to be uniform while realizing high capacitance, such that withstand voltage characteristics may be improved and cracking due to thermal impact may be suppressed, so that a high capacitance multilayer ceramic electronic component having excellent reliability can be realized.

As set forth above, according to the embodiments of the present invention, the thickness of the dielectric layers may be uniform while realizing high capacitance, thereby improving withstand voltage characteristics and suppressing cracking due to thermal impact, so that a high capacitance multilayer ceramic electronic component having excellent reliability can be realized.

While the present invention has been shown and described in connection with the embodiments, it will be apparent to those skilled in the art that modifications and variations can be made without departing from the spirit and scope of the invention as defined by the appended claims.

What is claimed is:

1. A multilayer ceramic electronic component, comprising:
a ceramic body including a plurality of dielectric layers laminated therein, each dielectric layer having an average thickness of 0.65 μm or less;
internal electrodes disposed to face each other while having each dielectric layer interposed therebetween in the ceramic body; and
external electrodes electrically connected to the internal electrodes,
wherein, when td denotes the average thickness of each of the dielectric layers and te denotes an average thickness of each of the internal electrodes, te/td≦0.77 is satisfied.

2. The multilayer ceramic electronic component of claim 1, wherein the internal electrodes respectively have an average thickness of 0.25 to 0.5 μM.

3. The multilayer ceramic electronic component of claim 1, wherein, when an area formed of the dielectric layers and the internal electrodes contributing to capacitance formation in the ceramic body is designated as an active area, a ratio of a volume of the dielectric layers to a volume of the internal electrodes in the active area is 1.3 or more.

4. The multilayer ceramic electronic component of claim 1, wherein the internal electrodes are laminated in an amount of 200 layers or more.

5. A multilayer ceramic electronic component, comprising:
a ceramic body including a plurality of dielectric layers laminated therein, each dielectric layer having an average thickness of 0.65 μm or less;
internal electrodes disposed to face each other while having each dielectric layer interposed therebetween in the ceramic body; and
external electrodes electrically connected to the internal electrodes,
wherein, when an area formed of the dielectric layers and the internal electrodes contributing to capacitance formation in the ceramic body is designated as an active area, a ratio of a volume of the dielectric layers to a volume of the internal electrodes in the active area is 1.3 or more.

6. The multilayer ceramic electronic component of claim 5, wherein the internal electrodes respectively have an average thickness of 0.25 to 0.5 μm.

7. The multilayer ceramic electronic component of claim 5, wherein the internal electrodes are laminated in an amount of 200 layers or more.

8. A method of manufacturing a multilayer ceramic electronic component, the method comprising:
preparing ceramic green sheets by using a slurry containing a ceramic powder;
forming internal electrode patterns on the respective ceramic green sheets by using a conductive paste containing a metal powder;
laminating and sintering the ceramic green sheets to form a ceramic body including dielectric layers and a plurality of internal electrodes disposed to face each other while having each dielectric layer interposed therebetween; and
forming external electrodes on exterior surfaces of the ceramic body,
wherein the dielectric layers respectively have an average thickness of 0.65 μm, and, when td denotes the average thickness of each of the dielectric layers and te denotes an average thickness of each of the internal electrodes, te/td≦0.77 is satisfied.

9. The multilayer ceramic electronic component of claim 8, wherein the internal electrodes respectively have an average thickness of 0.25 to 0.5 μm.

10. The multilayer ceramic electronic component of claim 8, wherein, when an area formed of the dielectric layers and the internal electrodes contributing to capacitance formation in the ceramic body is designated as an active area, a ratio of a volume of the dielectric layers to a volume of the internal electrodes in the active area is 1.3 or more.

11. The multilayer ceramic electronic component of claim 8, wherein the internal electrodes are laminated in an amount of 200 layers or more.
